(19) United States
(12) Patent Application Publication
(10) Pub. No.: US 2026/0202873 A1
(43) Pub. Date: Jul. 16, 2026

(54) FLIP-TYPE FILM STICKING DEVICE FOR ELECTRONIC DEVICE

(71) Applicant: Dongguan Xiyou Digital Co., Ltd., Hengli Town (CN)

(72) Inventor: Fuju Liu, Dongguan (CN)

(21) Appl. No.: 19/187,989

(22) Filed: Apr. 23, 2025

(30) Foreign Application Priority Data
Jan. 14, 2025 (CN) 202520089014.9

(51) Int. Cl. G06F 1/16

(52) U.S. Cl. CPC G06F 1/1609; G06F 1/1637; G06F 2200/1634

(57) ABSTRACT

A flip-type film sticking device for an electronic device is disclosed. The flip-type film sticking device includes an installation box for placing the electronic device; an installation slot is formed in the installation box for accommodating the electronic devices; one side of the installation box is flexibly connected with a cover for installing a film sticking assembly and engaging with the installation box; a receiving slot is formed in the cover for accommodating the film sticking assembly; by installing the cover on one side of the installation box, the film sticking assembly is installed onto the cover, replacing the existing method of placing the film sticking assembly directly in the installation box. Before the film is attached, there is no need to first attach the electronic device to the film sticking assembly.

### CROSS-REFERENCE TO RELATED APPLICATIONS

The present disclosure claims the priority of Chinese Utility Model Application No. 202520089014.9, filed on January 14, 2025, the entire contents of which are hereby incorporated by reference.

### FIELD

The present disclosure relates to the technical field of electronic equipment accessories, and more particularly, to a flip-type film sticking device for an electronic device.

### BACKGROUND

With the popularity of smart electronic devices, the touch screen has become an indispensable interactive interface in people's daily lives. To protect the touch screen from scratches and wear, users usually choose to attach a protective film on the screen. The traditional film sticking method mainly relies on manual visual alignment, which requires the operator to have certain skills, otherwise the protective film may not be accurately positioned, affecting the protective effect and aesthetics. In order to solve this problem, various film sticking devices have emerged in the market, among which the flip-type film sticking device, as a relatively novel film sticking device, has been favored by many consumers.

However, there are still many problems with the existing flip-type film sticking device, mainly including: Regarding the structure of the film sticking device, a film sticking assembly is at first positioned on the film sticking device, and then the electronic device is placed inside the film sticking device to achieve mutual correspondence between the electronic device and the protective film, and a cover on one side of the film sticking device is flipped over to press the electronic device and the film sticking assembly. By pulling a pulling film to remove a release film attached to the protective film, the protective film can be attached to the screen of the electronic device to complete the film sticking operation. Usually, such film sticking process requires the user to turn over the electronic device such that the screen of the electronic device is kept down and placed in the film sticking device, which is not ergonomic and reduces the user' experience. Moreover, such film sticking method inevitably causes uncontrollable situations during the sticking process. For example, after positioning the electronic device and the film sticking assembly, the cover may be deformed or moved during the pressing process due to force, causing the cover to be misaligned with the film sticking device and unable to evenly press the electronic device, reducing the attachment tightness of the film and the screen; furthermore, a positional deviation between the electronic device and the film sticking assembly may be caused, thereby affecting the quality of the film sticking.

### SUMMARY

In order to solve the above technical problems, the present disclosure provides a film-sticking device for an electronic device.

The technical solution of the present disclosure is implemented as follows:

A flip-type film sticking device for an electronic device, wherein the flip-type sticking device includes an installation box for placing the electronic device,an installation slot is formed in the installation box for accommodating the electronic device, and one side of the installation box is flexibly connected with a cover for installing a film sticking assembly and engaging with the installation box; a receiving slot is formed in the cover for accommodating the film sticking assembly .

In an embodiment, two positioning portions are respectively arranged on inner wall edges of both sides of the receiving slot for clamping into the installation box; the positioning portions include a first positioning strip and a second positioning strip respectively protruding from the both sides of the receiving slot.

In an embodiment, the first positioning strip and the second positioning strip are both strip shaped and protrude from a top surface of the corresponding inner wall edge of the receiving slot, and a distance between an outer side wall of the first positioning strip and an outer side wall of the second positioning strip which are away from the receiving slot is greater than or equal to a width of the installation slot.

In an embodiment, a first positioning member and a second positioning member are respectively arranged on both ends of an inner bottom wall of the receiving slot for fixing the film sticking assembly.

In an embodiment, the flip-type film sticking device according to claim 1, wherein several limiting protrusions protrude from an inner wall of the installation slot or supporting the electronic device.

In an embodiment, a cushion strip is arranged on the bottom wall of the receiving slot for supporting the film sticking assembly.

In an embodiment, the film sticking assembly includes a fixing film, a protective film, a release film, and a pulling film; a top surface of the fixing film is attached to the protective film, a top surface of the protective film is attached to the release film, and one end of the release film is connected to the pulling film; a first extension portion and a second extension portion respectively extends from both ends of the fixing film; a first positioning hole is defined in the first extension portion for clamping onto a first positioning member, and a second positioning hole is defined in the second extension portion for clamping onto a second positioning member.

In an embodiment, a third extension portion is arranged on one end of the release film, and an adhesive strip is arranged on a bottom of the third extension portion for being attached to the first extension portion; and one end of the pulling film is connected to the third extension portion.

In an embodiment, a pulling opening in communication with the installation slot is formed in one end of the installation box for accommodating one end of the pulling film, and a width of the pulling opening is greater than or equal to a width of the release film.

In an embodiment, a slot is formed in the end of the installation box and is spaced apart from the installation slot, and a joint portion is arranged inside the slot; a fixing column corresponding to the position of the joint portion protrudes from a top of the first positioning member; the joint portion is cylindrical, and the fixing column is inserted into the joint portion.

In an embodiment, a fastening member is arranged on an outer wall of a side of the cover, a fastening slot is formed in an outer wall of a side of the installation box for engaging with the fastening member; and the fastening member is sheet shaped and includes a protrusion engaged in the fastening slot.

Compared to existing technologies, the present disclosure has the following beneficial effects:

The present disclosure installs the cover on one side of the installation box and installs the film sticking assembly on the cover, which replaces the traditional method of placing the film sticking assembly directly in the installation box. Before the film sticking operation, there is no need to attach the electronic device to the film sticking assembly at first. The electronic device is directly placed in the installation box with the screen of the electronic device facing up, and then the cover with the film sticking assembly is flipped over to cover the installation box, such that the film sticking assembly corresponds to the screen and is attached to the screen. Since the film sticking assembly is installed on the cover, the electronic device and the film sticking assembly are not in contact with each other before the film sticking operation, and there is no need to position the electronic device on the film sticking assembly. Such configuration solves the problem that the improper operation of the electronic device and the film sticking assembly during the positioning process may cause the displacement of the film sticking assembly, and thus avoids the tilting of the protective film on the screen of the electronic device, simplifies the film sticking process, and allows the film sticking operation to be more ergonomic, thereby improving the user's experience.

### BRIEF DESCRIPTION OF THE DRAWINGS

To describe the technical solutions in the embodiments of the present disclosure more clearly, the following briefly introduces the accompanying drawings required for describing the embodiments or the prior art. Apparently, the accompanying drawings in the following description show merely some embodiments of the present disclosure, and persons of ordinary skill in the art may still derive other drawings from these accompanying drawings without creative efforts.

FIG. 1 is a schematic view of a flip-type film sticking device for an electronic device according to Embodiment 1 of the present disclosure;

FIG. 2 is another schematic view of the flip-type film sticking device according to Embodiment 1 of the present disclosure;

FIG. 3 is an exploded view of the flip-type film sticking device according to Embodiment 1 of the present disclosure;

FIG. 4 is an enlarged partial view of a part A in FIG. 3;

FIG. 5 is a schematic view showing that an installation box engages with a cover of a flip-type film sticking device for an electronic device according to Embodiment 2 of the present disclosure; and

FIG. 6 is a schematic view showing that an installation box engages with a cover of a flip-type film sticking device for an electronic device according to Embodiment 3 of the present disclosure;

### DESCRIPTION OF REFERENCE NUMERALS

1, installation box; 2, installation slot; 3, film sticking assembly; 31, fixing film; 311, first extension portion; 312, second extension portion; 313, first positioning hole; 314, second positioning hole; 32, protective film; 33, release film; 331, third extension portion; 332, adhesive strip; 34, pulling film; 4, cover; 5, receiving slot; 6, first positioning member; 61, fixing column; 7, second positioning member; 8, limiting protrusion; 9, cushion strip; 10, pulling opening; 11, first opening; 12, handle portion; 13, positioning portion; 14, block; 15, slot; 16, joint portion; 17, fastening member; 18, fastening slot.

### DETAILED DESCRIPTION

In order to make the objectives, features, and advantages of the present disclosure more obvious and understandable, the technical solutions in the embodiments of the present disclosure will be clearly and completely described below in conjunction with the accompanying drawings of the embodiments of the present disclosure. It is apparent that the embodiments described below are only a part of the embodiments of the present disclosure, not all of them. Based on the embodiments of the present disclosure, all other embodiments obtained by those skilled in the art without creative effort fall within the scope of protection of the present disclosure.

### Embodiment 1

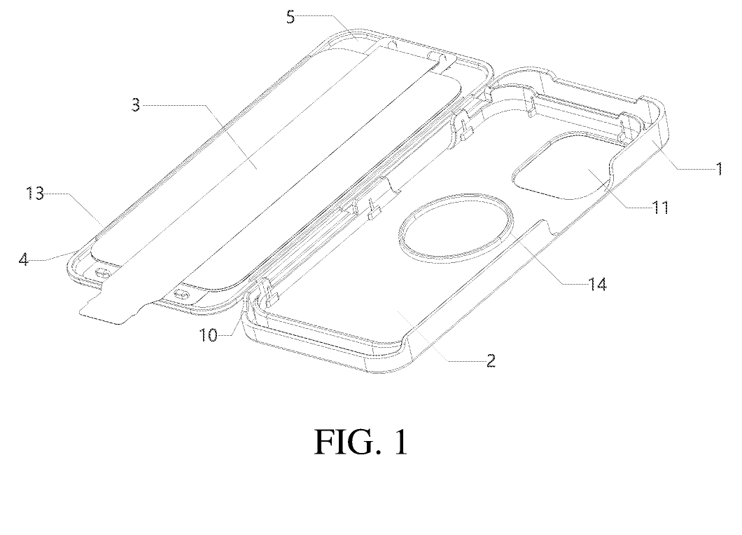

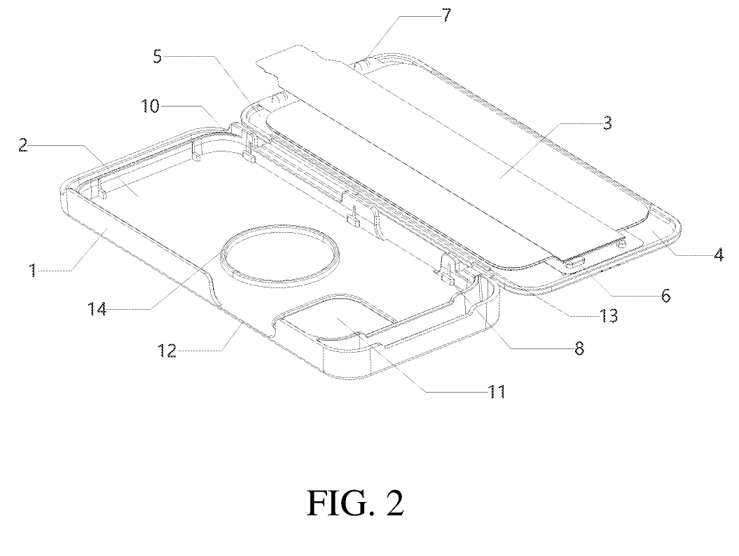

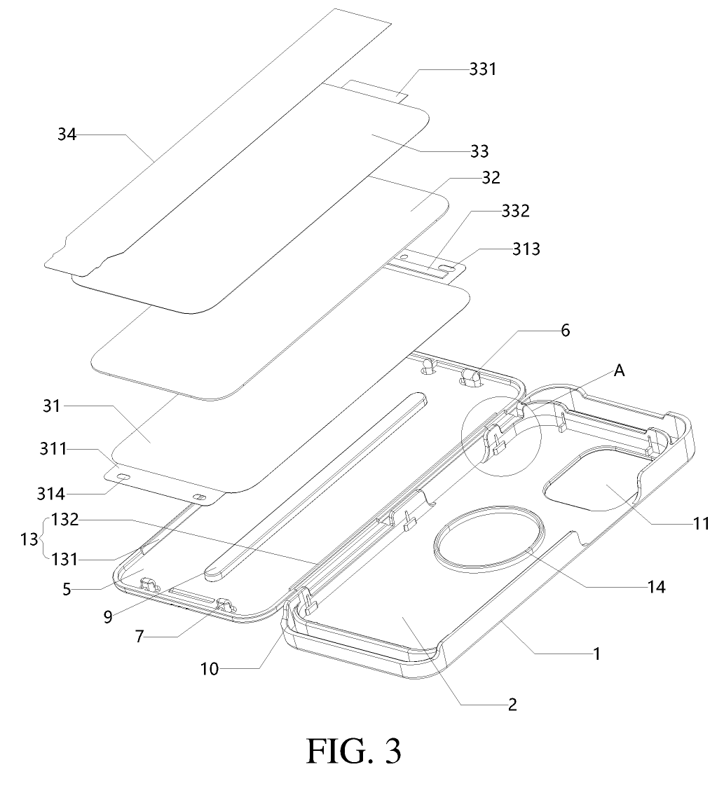

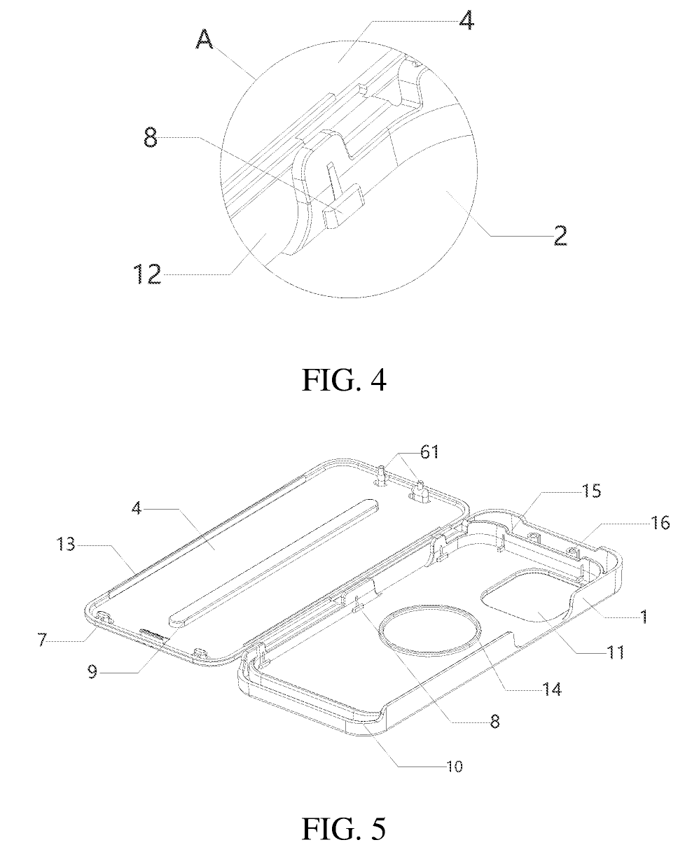

As shown in FIGS. 1-4, a flip-type film sticking device for an electronic device includes an installation box 1 for placing the electronic device. An installation slot 2 is formed in the installation box 1 for accommodating the electronic device, and one side of the installation box 1 is flexibly connected with a cover 4 for installing a film sticking assembly 3 and engaging with the installation box 1. A receiving slot 5 is formed in the cover 4 for accommodating the film sticking assembly 3.

In this embodiment, the cover 4 is flippable and is arranged on one side of the installation box 1, and the film sticking assembly 3 is installed on the cover 4. The installation box 1 is only used to place the electronic device. When a film is attached to a screen of the electronic device, the screen of the electronic device is kept facing up, such that the film sticking operation can better conform to ergonomics and improve the user's experience. At the same time, the film sticking device of the present disclosure is relatively light and thin, which can improve production efficiency. By flipping the cover 4 over, the film sticking assembly 3 on the cover 4 is in contact with the electronic device. Before the film is attached to the screen, the electronic device does not directly contact the film sticking assembly 3, which can prevent the original installation position of the film sticking assembly 3 from being affected when the electronic device is placed and positioned and thus avoid the deviation of the film sticking assembly 3.

Furthermore, two positioning portions 13 are respectively arranged on inner wall edges of both sides of the receiving slot 5 for clamping into the installation box 1. When the cover 4 is flipped over to a top of the installation box 1, the positioning portions 13 are clamped into openings formed in the top of the installation box 1 to position the cover 4. The positioning portions 13 are in contact with an inner wall of the installation box 1, stabilizing the cover 4 and preventing the cover 4 from being displaced due to force during the film sticking process. In an embodiment, the positioning portions 13 include a first positioning strip 131 and a second positioning strip 132 respectively protruding from the both sides of the receiving slot 5.

In an embodiment, the first positioning strip 131 and the second positioning strip 132 are strip shaped and respectively protrude from a top surface of the corresponding inner wall edge of the receiving slot 5. A distance between an outer side wall of the first positioning strip 131 and an outer side wall of the second positioning strip 132 which are away from the receiving slot 5 is greater than or equal to a width of the installation slot 2.

A first positioning member 6 and a second positioning member 7 are respectively arranged on two ends of a bottom wall of the receiving slot 5 for fixing the film sticking assembly 3.

Several limiting protrusions 8 are arranged on an inner wall of the installation slot 2 for supporting the electronic device. The limiting protrusions 8 are used to limit a placement height of the electronic device in the installation box 1. When the electronic device is placed in the installation box 1, a placement position of the electronic device is restricted. During the film sticking process, the electronic device may be in contact with the film sticking assembly 3. Heights of the limiting protrusions 8 directly affect a tightness degree between the screen of the electronic device and the film sticking assembly 3 during the film sticking process.

A cushion strip 9 is arranged on the bottom wall of the receiving slot 5 for supporting the film sticking assembly 3. The cushion strip 9 can support the film sticking assembly 3 to allow the attachment between the film sticking assembly 3 and the screen of the electronic device to be more tight during the film sticking process.

The film sticking assembly 3 includes a fixing film 31, a protective film 32, a release film 33, and a pulling film 34. A top surface of the fixing film 31 is attached to the protective film 32, and a top surface of the protective film 32 is attached to the release film 33. One end of the release film 33 is connected to the pulling film 34.

A first extension portion 311 and a second extension portion 312 are respectively arranged both ends of the fixing film 31. A first positioning hole 313 is defined in the first extension portion 311 for clamping onto the first positioning member 6, and a second positioning hole 314 is defined in the second extension portion 312 for clamping onto the second positioning member 7.

A third extension portion 331 is arranged on one end of the release film 33, and an adhesive strip 332 is arranged on a bottom of the third extension portion 331 for being attached to the first extension portion 311. One end of the pulling film 34 is connected to the third extension portion 331, and the release film 33 and the fixing film 31 are attached to each other through the adhesive strip 332, which can prevent the release film 33 from being easily torn off and the protective film 32 from being covered with dust.

In this embodiment, the fixing film 31 on the film sticking assembly 3 is provided with the first extension portion 311 and the second extension portion 312 at both ends, and the first positioning hole 313 is defined in the first extension portion 311 and the second positioning hole 314 is defined in the second extension portion 312. The first positioning hole 313 is clamped onto the first positioning member 6 arranged on one end of the cover 4, and the second positioning hole 314 is clamped onto the second positioning member 7 arranged on the other end of the cover 4, thereby installing the film sticking assembly 3 on the cover 4.

A pulling opening 10 is formed in one end of the installation box 1. The pulling opening 10 is in communication with the installation slot 2 and is used to accommodate one end of the pulling film 34 of the film sticking assembly 3. A width of the pulling opening 10 is greater than or equal to a width of the release film 33 of the film sticking assembly 3. When the cover 4 is flipped over to the top of the installation box 1, the pulling film 34 enters the pulling opening 10, allowing the user to pull the pulling film 34.

A block 14 is arranged on a bottom wall of the installation box 1 for supporting the electronic device.

A first opening 11 is formed in the bottom wall of the installation box 1 for accommodating camera components of the electronic device. At least one side of the installation box 1 is provided with a handle position 12, which facilitates the user to take out the electronic device from the installation box 1.

In some embodiments, several anti-slip pads are arranged on the bottom of the installation box 1 to prevent the sliding and displacement of the installation box 1 during the film sticking process from affecting the film sticking operation.

The working process and principle of the flip-type film sticking device of the present disclosure are as follows:

Firstly, the electronic device is placed in the installation slot 2 of the installation box 1, with the screen of the electronic device facing up. The cover 4 is then flipped over to ensure that the film sticking assembly 3 on the cover 4 is in contact with the screen of the electronic device. During the film sticking process, the filming sticking assembly 3 does not directly contact the electronic device, avoiding displacement and contamination of the filming sticking assembly 3. The positioning portion 13 arranged on the cover 4 engages with the top of the installation box 1, ensuring that the cover 4 is stable during the film sticking process and avoiding the displacement of the cover 4 due to force. The filming sticking assembly 3 is fixed to the cover 4 through the first positioning member 6 and the second positioning member 7, ensuring that the position of the filming sticking assembly 3 is accurate. By pulling the pulling film 34, the release film 33 can be removed from the protective film 32, and the protective film 32 can be attached to the screen of the electronic device.

By utilizing the structural design of the installation box 1 and the cover 4, precise alignment and attachment between the screen of the electronic device and the film sticking assembly 3 can be achieved. The limiting protrusions 8 of the installation box 1 restrict the placement height and the position of the electronic device. At the same time, the cushion strip 9 is arranged in the receiving slot 5 to ensure the tightness of the film sticking.

### Embodiment 2

As shown in FIG. 5, a flip-type film sticking device for an electronic device in accordance with Embodiment 2 is provided, which includes an installation box 1 for placing the electronic device. An installation slot 2 is formed in the installation box 1 for accommodating the electronic device. One side of the installation box 1 is flexibly connected with a cover 4 for installing a film sticking assembly 3 and engaging with the installation box 1. A receiving slot 5 is formed in the cover 4 for accommodating film sticking assembly 3.

In this embodiment, a flippable cover 4 is arranged on one side of the installation box 1, and the film sticking assembly 3 is installed on the cover 4. The installation box 1 is only used to place the electronic device. When a film is attached to the screen of the electronic device, the screen of the electronic device is kept facing up, such that the film sticking operation can better conform to ergonomics and improve the user's experience. At the same time, the flip-type filming sticking device of the present disclosure is relatively light and thin, which can improve production efficiency. By flipping the cover 4 over, the film sticking assembly 3 on the cover 4 is in contact with the electronic device. Before the film is attached to the screen, the electronic device does not directly contact the film sticking assembly 3, which can prevent the original installation position of the film sticking assembly 3 from being affected when the electronic device is placed and positioned and thus avoid the deviation of the film sticking assembly 3.

Two positioning portions 13 are respectively arranged on inner wall edges of both sides of the receiving slot 5 for clamping into the installation box 1. When the cover 4 is flipped over to a top of the installation box 1, the positioning portions 13 are clamped into openings formed in the top of the installation box 1 to position the cover 4. The positioning portions 13 are in contact with an inner wall of the installation box 1, stabilizing the cover 4 and preventing the cover 4 from being displaced due to force during the film sticking process. In an embodiment, the positioning portions 13 include a first positioning strip 131 and a second positioning strip 132 respectively protruding from the both sides of the receiving slot 5.

In an embodiment, the first positioning strip 131 and the second positioning strip 132 are strip shaped and respectively protrude from a top surface of the corresponding inner wall edge of the receiving slot 5. A distance between an outer side wall of the first positioning strip 131 and an outer side wall of the second positioning strip 132 which are away from the receiving slot 5 is greater than or equal to a width of the installation slot 2.

A first positioning member 6 and a second positioning member 7 are respectively arranged on two ends of a bottom wall of the receiving slot 5 for fixing the film sticking assembly 3.

Several limiting protrusions 8 are arranged on an inner wall of the installation slot 2 for supporting the electronic device. The limiting protrusions 8 are used to limit a placement height of the electronic device in the installation box 1. When the electronic device are placed in the installation box 1, a placement position of the electronic device is restricted. During the film sticking process, the electronic device can be in contact with the film sticking assembly 3. Heights of the limiting protrusions 8 directly affect a tightness degree between the screen of the electronic device and the film sticking assembly 3 during the film sticking process.

Furthermore, a cushion strip 9 is arranged on a bottom wall of the receiving slot 5 for supporting the film sticking assembly 3. The cushion strip 9 can support the film sticking assembly 3 to allow the attachment between the film sticking assembly 3 and the screen of the electronic device to be more tight during the film sticking process.

The film sticking assembly 3 includes a fixing film 31, a protective film 32, a release film 33, and a pulling film 34. A top surface of the fixing film 31 is attached to the protective film 32, and a top surface of the protective film 32 is attached to the release film 33. One end of the release film 33 is connected to the pulling film 34.

A first extension portion 311 and a second extension portion 312 are respectively arranged on two ends of the fixing film 31. A first positioning hole 313 is defined in the first extension portion 311 for clamping onto the first positioning member 6, and a second positioning hole 314 is defined in the second extension portion 312 for clamping onto the second positioning member 7.

A third extension portion 331 is arranged on one end of the release film 33, and an adhesive strip 332 is arranged on the bottom of the third extension portion 331 for being attached to the first extension portion 311. One end of the pulling film 34 is connected to the third extension portion 331, and the release film 33 and the fixing film 31 are attached to each other through the adhesive strip 332, which can prevent the release film 33 from being easily torn off and the protective film 32 from being covered with dust.

In this embodiment, the fixing film 31 on the film sticking assembly 3 is provided with the first extension portion 311 and the second extension portion 312 at both ends, and the first positioning hole 313 is defined in the first extension portion 311 and the second positioning hole 314 is defined in the second extension portion 312. The first positioning hole 313 is clamped to the first positioning member 6 arranged on one end of the cover 4, and the second positioning hole 314 is clamped to the second positioning member 7 arranged on the other end of the cover 4, thereby installing the film sticking assembly 3 on the cover 4.

A pulling opening 10 is formed in one end of the installation box 1. The pulling opening 10 is in communication with the installation slot 2 and is used to accommodate one end of the pulling film 34 of the film sticking assembly 3. A width of the pulling opening 10 is greater than or equal to a width of the release film 33 of the film sticking assembly 3. When the cover 4 is flipped over to the top of the installation box 1, the pulling film 34 enters the pulling opening 10, allowing the user to pull and stretch the pulling film 34 easily.

A slot 15 spaced apart from the installation slot 2 is formed in one end of the installation box 1, and a joint portion 16 is arranged inside the slot 15. A fixing column 61 corresponding to the joint portion 16 protrudes from a top of the first positioning member 6. The joint portion 16 is cylindrical, and the fixing column 61 is inserted into the joint portion 16.

In this embodiment, the cover 4 can be quickly positioned and clamped onto the installation box 1 through the engagement between the fixing column 61 and the joint portion 16. When the fixing column 61 is inserted into the joint portion 16, the cover 4 can be stably installed on the installation box 1.

A block 14 is arranged on a bottom wall of the installation box 1 for supporting the electronic device.

A first opening 11 is formed in the bottom wall of the installation box 1 for accommodating camera components of the electronic device. At least one side of the installation box 1 is provided with a handle position 12, which facilitates the user to take out the electronic device from the installation box 1.

In some embodiments, several anti-slip pads are arranged on the bottom of the installation box 1 to prevent the sliding and displacement of the installation box 1 during the film sticking process from affecting the film sticking operation.

### Embodiment 3

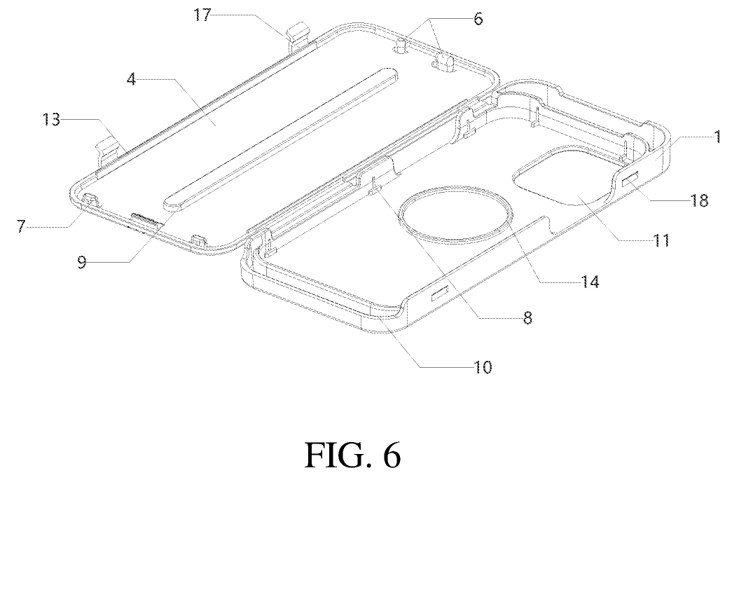

As shown in FIG. 6, a flip-type film sticking device for an electronic device in accordance with Embodiment 3 is provided, which includes an installation box 1 for placing the electronic device. An installation slot 2 is formed in the installation box 1 for accommodating the electronic device. One side of the installation box 1 is flexibly connected with a cover 4 for installing a film sticking assembly 3 and engaging with the installation box 1. A receiving slot 5 is formed in the cover 4 for accommodating the film sticking assembly 3.

In this embodiment, a flippable cover 4 is arranged on one side of the installation box 1, and the film sticking assembly 3 is installed on the cover 4. The installation box 1 is only used to place the electronic device. When a film is attached to a screen of the electronic device, the screen of the electronic device is kept facing up, such that the film sticking operation can better conform to ergonomics and improve the user's experience. At the same time, the flip-type film sticking device of the present disclosure is relatively light and thin, which can improve production efficiency. By flipping the cover 4 over, the film sticking assembly 3 on the cover 4 is in contact with the electronic device. Before the film is attached to the screen, the electronic device does not directly contact the film sticking assembly 3, which can prevent the original installation position of the film sticking assembly 3 from being affected when the electronic device is placed and positioned and thus avoid the deviation of the film sticking assembly 3.

Two positioning portions 13 are respectively arranged on inner wall edges of both sides of the receiving slot 5 for clamping into the installation box 1. When the cover 4 is flipped over to a top of the installation box 1, the positioning portions 13 are clamped into openings formed in the top of the installation box 1 to position the cover 4. The positioning portions 13 are in contact with an inner wall of the installation box 1, stabilizing the cover 4 and preventing the cover 4 from being displaced due to force during the film sticking process. In an embodiment, the positioning portions 13 include a first positioning strip 131 and a second positioning strip 132 respectively protruding from the both sides of the receiving slot 5.

In an embodiment, the first positioning strip 131 and the second positioning strip 132 are strip shaped and respectively protrude from a top surface of the corresponding inner wall edge of the receiving slot 5. A distance between an outer side wall of the first positioning strip 131 and an outer side wall of the second positioning strip 132 which are away from the receiving slot 5 is greater than or equal to a width of the installation slot 2.

A first positioning member 6 and a second positioning member 7 are respectively arranged on two ends of a bottom wall of the receiving slot 5 for fixing the film sticking assembly 3.

Several limiting protrusions 8 are arranged on an inner wall of the installation slot 2 for supporting the electronic device. The limiting protrusions 8 are used to limit a placement height of the electronic device in the installation box 1. When the electronic device is placed in the installation box 1, a placement position of the electronic device position is restricted. During the film sticking process, the electronic device can be in contact with the film sticking assembly 3. Heights of the limiting protrusions 8 directly affect a tightness degree between the electronic device screen and the film sticking assembly 3 during the film sticking operation.

A cushion strip 9 is arranged on a bottom wall of the receiving slot 5 for supporting the film sticking assembly 3. The cushion strip 9 can support the film sticking assembly 3 to allow the attachment between the film sticking assembly 3 and the screen of the electronic device to be more tight during the film sticking process.

The filming sticking assembly 3 includes a fixing film 31, a protective film 32, a release film 33, and a pulling film 34. A top surface of the fixing film 31 is attached to the protective film 32, and a top surface of the protective film 32 is attached to the release film 33. One end of the release film 33 is connected to the pulling film 34.

A first extension portion 311 and a second extension portion 312 are respectively arranged on both ends of the fixing film 31. A first positioning hole 313 is defined in the first extension portion 311 for clamping onto the first positioning member 6, and a second positioning hole 314 is defined in the second extension portion 312 for clamping onto the second positioning member 7.

A third extension portion 331 is arranged on one end of the release film 33, and an adhesive strip 332 is arranged on the bottom of the third extension portion 331 for being attached to the first extension portion 311. One end of the pulling film 34 is connected to the third extension portion 331, and the release film 33 and the fixing film 31 are attached to each other through the adhesive strip 332, which can prevent the release film 33 from being easily torn off and the protective film 32 from being covered with dust.

In this embodiment, the fixing film 31 on the film sticking assembly 3 is provided with the first extension portion 311 and the second extension portion 312 at both ends, and the first positioning hole 313 is defined in the first extension portion 311 and the second positioning hole 314 is defined in the second extension portion 312. The first positioning hole 313 is clamped onto the first positioning member 6 arranged on one end of the cover 4, and the second positioning hole 314 is clamped onto the second positioning member 7 arranged on the other end of the cover 4, thereby installing the film sticking assembly 3 on the cover 4.

A pulling opening 10 is formed in one end of the installation box 1. The pulling opening is in communication with the installation slot 2 and is used to accommodate one end of the pulling film 34 of the film sticking assembly 3. A width of the pulling opening 10 is greater than or equal to a width of the release film 33 of the film sticking assembly 3. When the cover 4 is flipped over to the top of the installation box 1, the pulling film 34 enters the pulling opening 10, allowing the user to pull and stretch the pulling film 34 easily.

Two fastening members 17 are arrange on an outer wall of one side of the cover 4, and two fastening slots 18 are formed in an outer wall of one side of the installation box 1 for respectively engaging with the fastening members 17.

Each of the fastening member 17 is sheet shaped and provided with a protruding portion which can be engaged in the corresponding fastening slot 18. In this embodiment, during the film sticking process, when the cover 4 and the installation box 1 are engaged with each other, the fastening member 17 arranged on the cover 4 engages with the fastening slot 18 formed in the installation box 1, which can position the cover 4 while providing a tight engagement between the cover 4 with the installation box 1, preventing the displacement or detachment between the cover 4 and the installation box 1, and improving the stability of the engagement between the cover 4 and the installation box 1.

A block 14 is arranged on a bottom wall of the installation box 1 for supporting the electronic device.

A first opening 11 is formed in the bottom wall of the installation box 1 for accommodating camera components of the electronic device. At least one side of the installation box 1 is provided with a handle position 12, which facilitates the user to take out the electronic device from the installation box 1.

In some embodiments, several anti-slip pads are arranged on the bottom of the installation box 1 to prevent the sliding and displacement of the installation box 1 during the film sticking process from affecting the film sticking operation.

It is understandable that the above-mentioned technical features may be used in any combination without limitation. The above descriptions are only the embodiments of the present disclosure, which do not limit the scope of the present disclosure. Any equivalent structure or equivalent process transformation made by using the content of the description and drawings of the present disclosure, or directly or indirectly applied to other related technologies in the same way, all fields are included in the scope of patent protection of the present disclosure.

What is claimed is:

1. A flip-type film sticking device for an electronic device, wherein the flip-type sticking device comprises an installation box (1) for placing the electronic device; an installation slot (2) is formed in the installation box (1) for accommodating the electronic device, and one side of the installation box (1) is flexibly connected with a cover (4) for installing a film sticking assembly (3) and engaging with the installation box (1); and a receiving slot (5) is formed in the cover (4) for accommodating the film sticking assembly (3).

2. The flip-type film sticking device according to claim 1, wherein two positioning portions (13) are respectively arranged on inner wall edges of both sides of the receiving slot (5) for clamping into the installation box (1);
the positioning portions (13) comprise a first positioning strip (131) and a second positioning strip (132) respectively protruding from the both sides of the receiving slot (5).

3. The flip-type film sticking device according to claim 2, wherein the first positioning strip (131) and the second positioning strip (132) are both strip shaped and respectively protrude from a top surface of the corresponding inner wall edge of the receiving slot (5), and a distance between an outer side wall of the first positioning strip (131) and an outer side wall of the second positioning strip (132) which are away from the receiving slot (5) is greater than or equal to a width of the installation slot (2).

4. The flip-type film sticking device according to claim 2, wherein a first positioning member (6) and a second positioning member (7) are respectively arranged on both ends of an inner bottom wall of the receiving slot (5) for fixing the film sticking assembly (3).

5. The flip-type film sticking device according to claim 1, wherein several limiting protrusions (8) protrude from an inner wall of the installation slot (2) for supporting the electronic device.

6. The flip-type film sticking device according to claim 4, wherein a cushion strip (9) is arranged on the bottom wall of the receiving slot (5) for supporting the film sticking assembly (3).

7. The flip-type film sticking device according to claim 1, wherein the film sticking assembly (3) comprises a fixing film (31), a protective film (32), a release film (33), and a pulling film (34); a top surface of the fixing film (31) is attached to the protective film (32), a top surface of the protective film (32) is attached to the release film (33), and one end of the release film (33) is connected to the pulling film (34);
a first extension portion (311) and a second extension portion (312) respectively extends from both ends of the fixing film (31); a first positioning hole (313) is defined in the first extension portion (311) for clamping onto a first positioning member (6), and a second positioning hole (314) is defined in the second extension portion (312) for clamping onto a second positioning member (7);
a third extension portion (331) is arranged on one end of the release film (33), and an adhesive strip (332) is arranged on a bottom of the third extension portion (331) for being attached to the first extension portion (311); and one end of the pulling film (34) is connected to the third extension portion (331).

8. The flip-type film sticking device according to claim 7, wherein a pulling opening (10) in communication with the installation slot (2) is formed in one end of the installation box (1) for accommodating one end of the pulling film (34), and a width of the pulling opening (10) is greater than or equal to a width of the release film (33).

9. The flip-type film sticking device according to claim 4, wherein a slot (15) is formed in the end of the installation box (1) and is spaced apart from the installation slot (2), and a joint portion (16) is arranged inside the slot (15); a fixing column (61) corresponding to the position of the joint portion (16) protrudes from a top of the first positioning member (6); the joint portion (16) is cylindrical, and the fixing column (61) is inserted into the joint portion (16).

10. The flip-type film sticking device according to claim 1, wherein a fastening member (17) is arranged on an outer wall of a side of the cover (4), a fastening slot (18) is formed in an outer wall of a side of the installation box (1) for engaging with the fastening member (17); and
the fastening member (17) is sheet shaped and comprises a protrusion engaged in the fastening slot (18).
